(19) United States
(12) Patent Application Publication
(10) Pub. No.: US 2008/0060052 A1
(43) Pub. Date: Mar. 6, 2008

(54) Method Of Safe Certification Service

(76) Inventors: Jay-Yeob Hwang, Giyunggi-do (KR); Ki-Ho Yang, Seoul (KR)

Correspondence Address: BACON & THOMAS, PLLC, 625 SLATERS LANE, FOURTH FLOOR, ALEXANDRIA, VA, 22314, US

(21) Appl. No.: 10/573,419

(22) PCT Filed: Sep. 25, 2004
(86) PCT No.: PCT/KR04/02495

§ 371 Date: Feb. 2, 2007

(30) Foreign Application Priority Data
Sep. 25, 2003 (KR) 10-2003-0066452
Jul. 8, 2004 (KR) 10-2004-0053149
Aug. 30, 2004 (KR) 10-2004-0068356

(51) Int. Cl. H04L 9/32

(52) U.S. Cl. 726/2

(57) ABSTRACT

The present invention relates to safe authentication. According to the present invention, a security access service method includes an authentication step by the input of text, an access location tracking step, an authentication step by the input of coordinates, and an access history report step.

### TECHNICAL FIELD

The present invention relates to authentication of a user, and more particularly, to technologies capable of preventing fraudulent use of an ID and a password of an individual, which are stolen through keyboard input information, and the drain of a password of a button input type of an entrance door lock device.

### BACKGROUND ART

A variety of security programs for PCs have been commercialized. They provide a function of monitoring illegal invasion for hacking or whether or not a hacking program has been installed, and the like.

Further, lots of Internet websites provide services in which if a user checks a security access option upon logging in, the user's ID and password are encrypted using 128 bits SSL (Secure Sockets Layer) of an international standard, which is used in Internet banking, card payment, etc., so that a hacker cannot intercept those information.

### Technical Problem

However, the conventional security program for the PCs operates only in a corresponding computer. Thus, if a user tries to open his/her e-mails using other's computers, those information is exposed to the danger of hacking.

Also, the conventional security access service is helpless in the face of a keyboard input information hacking program installed within a computer.

Further, a current door lock device using a button has a disadvantage in that the password is likely to be exposed to an accompanied person.

Accordingly, it is an object of the present invention to provide an authentication method which enables both a security access in any computer and a safe door lock.

### Advantageous Effects

As described above, the present invention is advantageous in that it is very excellent in terms of the security of login information in any computer regardless of whether or not a security program is installed, the security as a door lock device, the prevention of an authentication attempt by third parties, and the security against phishing. Further, the present invention is advantageous in that it can expand the band of a password even in a small-sized keypad such as a mobile phone, and it allows a user to safely report in case of emergence.

### BRIEF DESCRIPTION OF DRAWINGS

FIG. 1 is a flowchart illustrating a main process flow of the present invention;

FIG. 2 shows an example that clicks on an image;

FIG. 3 shows an example that reports the past access history upon logging in;

FIGS. 4 and 5 show another embodiments of an authentication method by the input of coordinates.

FIG. 6 shows an embodiment in which numbers are indicated every coordinates not coordinate writing;

FIGS. 7 and 8 show another embodiments of an authentication method by the input of coordinates;

FIG. 9 shows an embodiment of a non-response screen against the manipulation of a direction key;

FIG. 10 illustrates a setting screen for producing a personalization set;

FIG. 11 shows an embodiment in which the present invention is applied to a mobile phone;

FIG. 12 shows an example of a user profile table for an authentication service according to the present invention; and

FIG. 13 shows an example of an interface for registering a main computer according to the present invention.

### BEST MODE FOR CARRYING OUT THE INVENTION

The present invention is composed of four main steps. Each of the steps will now be described.

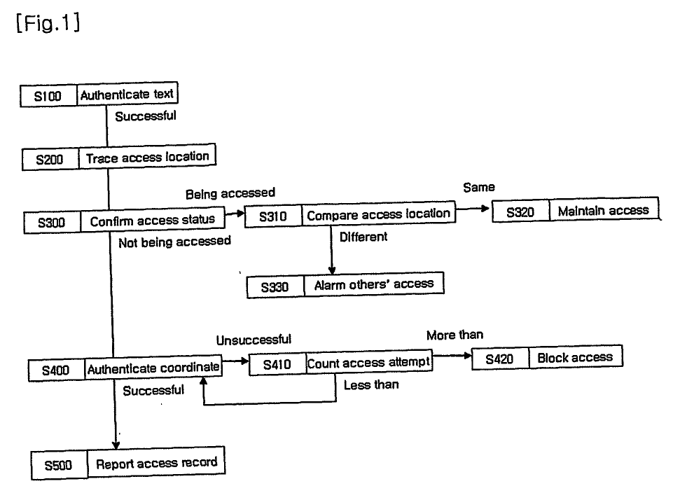

FIG. 1 is a flowchart illustrating a main process flow of the present invention.

1. Authentication step by text input (S100)

This step is the most common method in which an ID and a password are inputted -through the keyboard for authentication. Thus, detailed description on this step will be omitted.

2. Access location tracking step (S200)

If a user passes through the authentication step using the text input, the process proceeds to a web page for an authentication step through coordinate input. At this time, a JAVA applet that performs an access location tracking function is automatically downloaded into the user's computer, and then reports the user's current access location to a server. The server stores this information.

Description on technology in which JAVA applet tracks an access location can be found in Korean Patent Application No. 10-2001-0027537.

3. Authentication step through coordinate input (S400)

If the user's access location is tracked, the user is provided with a screen on which a predetermined image and other images are displayed randomly in order, so that the user clicks on the predetermined image correctly. At this time, the predetermined image can be one or plural. It is determined that authentication is successful only when the user clicks on the predetermined image correctly. Alternately, the user can click on a second password consisting of a character string through a mouse.

At this time, the number of available attempts can be properly limited (S410), so that a hacker is discouraged to make an attempt on hacking with the user's access location exposed (S420).

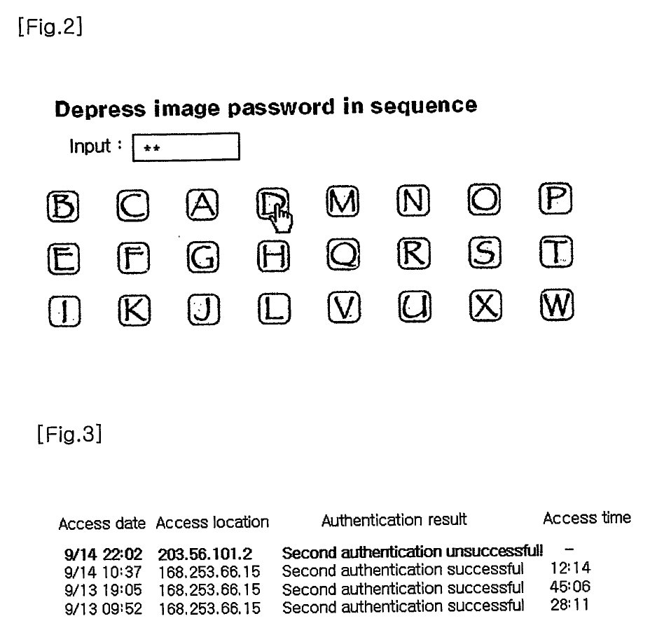

FIG. 2 shows an example that clicks on an image.

4. Access history report step (S330, S500)

If someone attempts access in a state where a user is being accessed, the location of the person who attempts access, which is obtained in the access location tracking step, and the access location of a current login status of the user are compared (S310). If they are not the same, the user of the current login status is immediately informed of the access location of the person who attempts access (S330). The user can report the access location of the person so that the hacking criminal can be caught.

If they are the same, the obtained positional information of the person who attempts access is always reported to the user in a next login (S500). More particularly, if there is a case where clicking on an image is failed, an alarm of a higher level is provided so that the user can prepare for hacking.

FIG. 3 shows an example that reports the past access history upon logging in.

Of the steps described above, the step of receiving the coordinates of the image is to prevent anyone who steals information inputted through the keyboard from making fraudulent use of others' ID since the conventional login method is mainly depending upon the keyboard. That is, if a person who attempts access does not click on a predetermined image correctly although he has stolen information inputted through the keyboard, he fails in login.

Further, in the access location tacking step, if a user attempts clicking on an image, the user's access location is exposed. Thus, the user will not dare to make an attempt of he does not know a predetermined image.

Moreover, in the authentication step through the keyboard input, the speed of clicking on the mouse becomes slows only with authentication by clicking on the mouse. Thus, since surrounding person when login is made can easily memorize an image, this step is for preventing a user from attempting hacking only with the memorized image. That is, this employs the fact that since the input of the keyboard is generally made by depressing several keys immediately, it is difficult to perceive the input. That is, a dual security system is implemented by allowing the input to be made through the keyboard and the mouse, separately.

Hereinafter, various embodiments of the authentication method by the input of coordinates will be described.

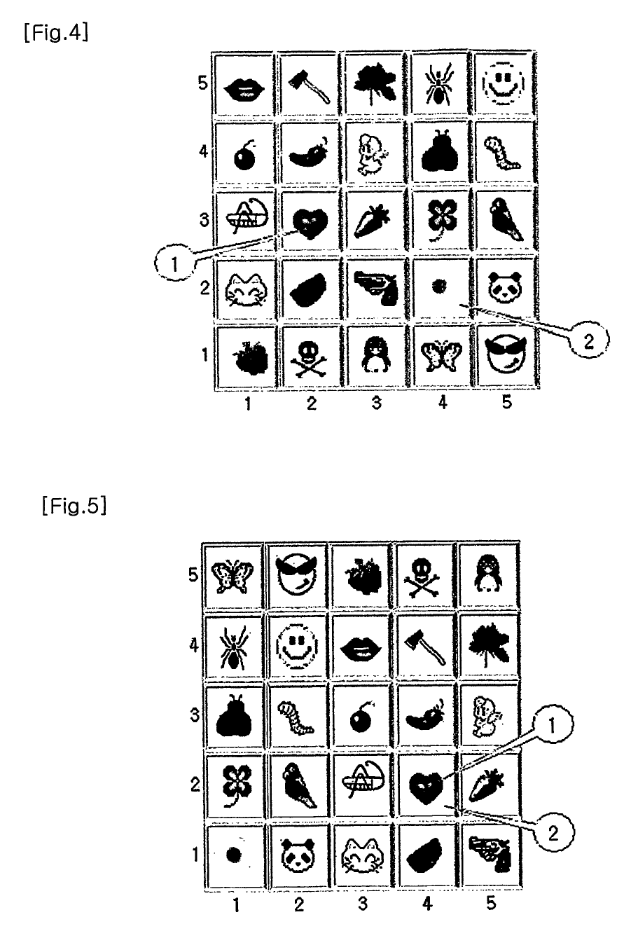

FIGS. 4 and 5 show another embodiments of the authentication method by the input of coordinates.

This method employs key coordinates and key images. In this method, if a user hits a predetermined key image to a predetermined key coordinate, authentication is successful.

For example, it is assumed that key coordinates of a user are (4, 2), and a key image is a heart pattern 1. (4, 2, heart pattern) is recorded in the user's personal information DB of the server as second authentication information. In the server, all the patterns are randomly mixed and an image table as shown in FIG. 4 is transmitted to the user's terminal. At this time, (2, 3), which is the position of the key image 1 of the image table in which all the patterns are randomly mixed, is recorded. The user inspects closely where the heart pattern 1 being his the key image shown on the screen is located, and then controls a direction key so that his heart pattern 1 is located in the key coordinates (4, 2). In FIG. 4, since the heart pattern 1 is (2, 3), if the right direction key is pressed twice and a down direction key 1 is pressed once, the entire images are shifted in the direction of the direction key. Thus, the heart pattern 1 located at (2, 3) is located at (4, 2), as shown in FIG. 5. If the enter key is pressed, authentication is successful. According to the manipulation of the direction key, the server continues to shift (2, 3), compares coordinates immediately before the enter key is inputted with the key coordinates, and if they are the same, considers that authentication is successful. In this method, a total of 25 images are shifted together. Thus, it is very difficult to know which image corresponds to which coordinates although others behind sees the screen. Moreover, although manipulation information of the direction key is stolen, authentication will not be successful only with the same method because the key image is located at a different position next time. In this case, the shift rule is a method in which an image located at the end in the traveling direction like 1-2-3-4-5-1 is shifted toward a first position of the direction.

Furthermore, in this method, the key coordinates can be newly designated every time using a second key image.

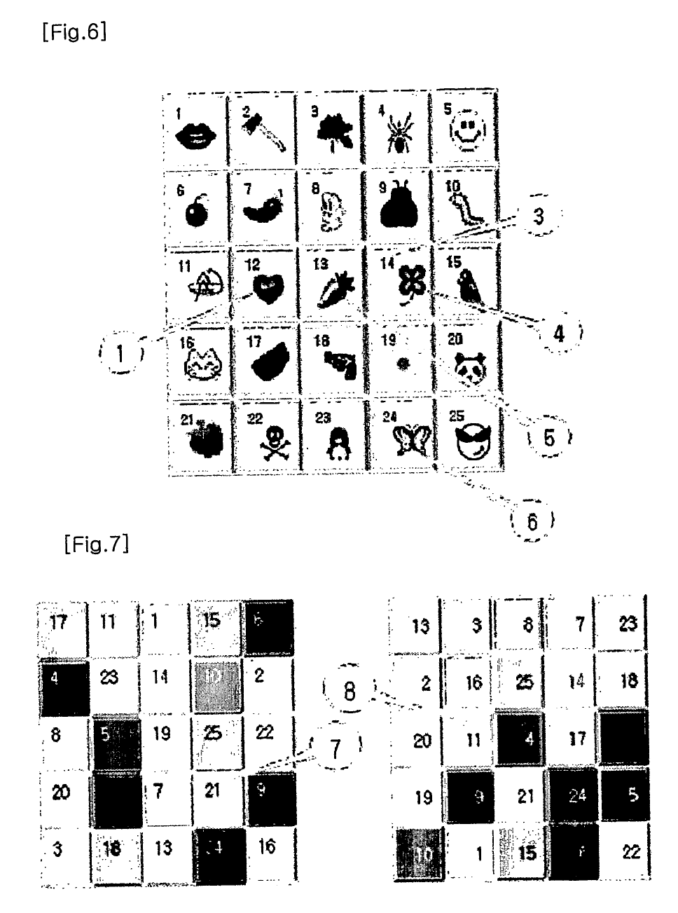

FIG. 6 shows an embodiment in which numbers are indicated every coordinates not coordinate writing.

In this embodiment, assuming that the heart pattern 1 is a first key image and a second key image is a clover pattern 4, a fourteenth position 3 where the clover pattern of the second key image is initially located becomes key coordinates. That is, if the first key image is moved to the position where the second key image is initially located, authentication is successful.

In this method, since key coordinates are changed every time, it is easy to memory the key coordinates by attaching the number 3 than coordinates such as (4, 3). A user who receives the image table as shown in FIG. 6 finds a heart pattern 1 being his first key image, finds a clover pattern 4 being a second key image, memorizes the number 14 being its position number, and then manipulates a direction key in order to position the heart pattern 1 at the 14 position. At this time, memorizing the position number of the clover pattern is for not to lose the first position 3 since the clover pattern is also moved when the heart pattern is moved. Therefore, it can be thought that the position 3 designated by the second key image not the second key image is hit. The user can easily memorize the key images using the name of the images, by producing memorizing sentences such as “I love clover” (a heart can be moved to a position where the clover was located), “Carrot to a panda” (a carrot is moved to a position where the panda was located).

For this method, when the server newly produces the image table before transmission, coordinates of each key image can be recorded, and movement of the coordinates can be calculated according to key manipulation of the user.

At this time, another interesting and useful functions such as a booby trap key 5 and a report key 6 can be thought.

Both the booby trap key and the report key are keys predetermined by a user. In this embodiment, the user sets a carrot 5 as the booby trap key, and a butterfly 6 as the report key. The booby trap key is a key indicating a position through which passage is not allowed when the key image is moved. That is, if the order of a position number 12-13-14 is moved in FIG. 6, a position 13 where the carrot is located is a booby trap key 5. Thus, an alarm is generated from a PC speaker and authentication is thus unsuccessful. That is, it is preferred that a path of 12-11-15-14, 12-7-8-9-14, etc. be used away from the carrot.

Further, if the booby trap key is trapped during the authentication process, the booby trap key transmits an alarm message to a user via SMS or e-mail so that the user can take a proper action. For example, URL, which can receive a report, can be included in the alarm message. If a report is received, a guard can go to a spot in order to catch a criminal.

The report key 6 allows a user to make report without being noticed if a criminal enters a company or a home by threats or when withdraws cash, in the case where the report key 6 is used as an authentication device in a door lock device, a bank cash dispenser, etc. If the user deceives the second key image into considering it to be the butterfly 6 of the report key or directly manipulating it, authentication is successful and thus sets the criminal at ease. In this case, however, a report is automatically made to the police or a guard company. That is, the report key can be a function in which the report function is added to the function of the second key image.

The booby trap key and the report key further increases the level of a danger that attempts authentication in order for an illegal user to disguise himself as others, thereby maximizing a prevention effect.

Further, a method of assigning a number to each position shown in this method can be applied to the method of FIG. 4. That is, in the method of FIG. 4, you can memorize the heart pattern at the number 19 instead of memorizing that the heart pattern is at the position (4, 2).

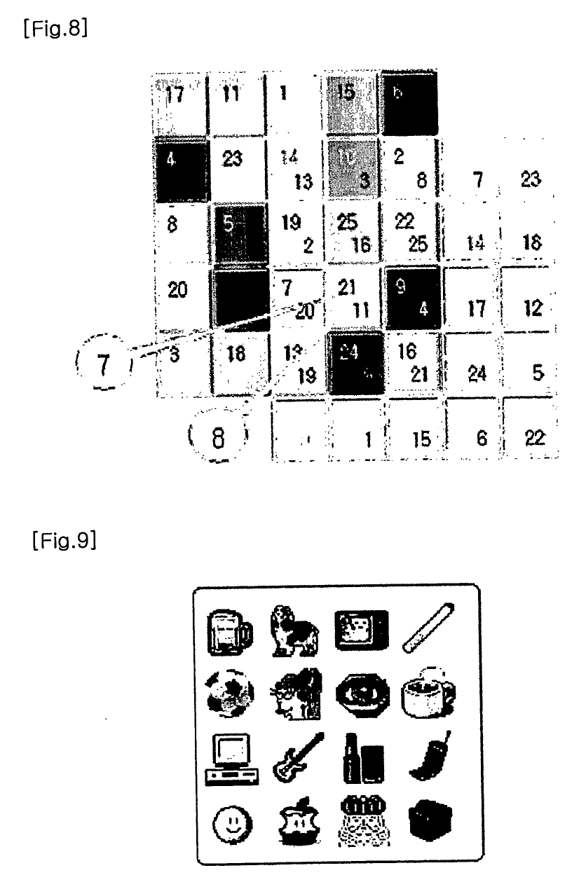

FIGS. 7 and 8 show another embodiments of an authentication method by the input of coordinates. This method is a case where key images form a pair such as 21(7) and 11(8).

21 is found in a left image table of FIG. 7, and 11 is found in a right image table of FIG. 7. Then, two key images are overlapped by dragging the right image table using the mouse, and are then dropped. In this case, if there is (21, 11) among various pairs of overlapped images, authentication is successful. Even in this case, the arrangement of the image tables is randomly changed in order every time. Thus, even if manipulation information of the mouse is known, next authentication will be unsuccessful. Further, since several pairs of images are overlapped at a time, others behind will not know which image pair is which key pair. In this method, if two image tables correspond to the key image pair when the server produces the image tables, others can easily know it since too less pairs of the images are overlapped. Thus, in order to prevent this, the image tables in the case where too less pairs of the images are overlapped are discarded, and new image tables are generated.

The above-described methods of FIGS. 4 and 6 correspond to a method in which the process of hitting the key image is safe although others steal a glance at it. In order to accomplish the object, first, a key image and key coordinates (or a second key image arranged within a second image table) that must correspond to its key image must be known to a user himself. Second, when the position of the key image is manipulated, all other images are manipulated at the same time in the same direction and as long as the same distance. Thus, although others watch it, they do not know which image is manipulated. Since the arrangement of image tables is differently presented every time, authentication is unsuccessful only with the same manipulation value although the manipulation value is known.

Furthermore, even if the direction key is manipulated, the same effect can be obtained although all the images are never moved. In this case, the user can draw a pointer over the key image in his mind, and moves the pointer in his mind together to the key coordinates according to the manipulation of the direction key. That is, if the images are moved, the pointer is also moved, but if the images are not moved, the pointer is not moved. Thus, others who see it from the side do not which image is manipulated.

FIG. 9 shows an embodiment of a non-response screen against the manipulation of a direction key.

In the embodiment of FIG. 9, if a passage rule is a 2 point passage type starting from a key image, and a key image, a through coordinate image and a terminal coordinate image are beer, a soccer ball and television, a sentence for memorizing can be “Watch a soccer relay while drinking beer”. In the example shown in FIG. 9, a distance from beer to the soccer ball is one box downwardly, and a distance from the soccer ball to television is two boxes to the right and one box upwardly. A total manipulation process is “a down direction key once, enter, a right direction key twice, and an up direction key once, enter”.

An embodiment of a personalization set that prepares for phishing will now be described.

Description on the personalization set will be made assuming the case of FIG. 9.

The method such as FIG. 9 is advantageous in that a personalization set in preparation for phishing can be easily implemented. That is, since sets to pass are differently registered every person, sets different every person are presented. Thus, others' key image and passage points cannot be known using bogus sets.

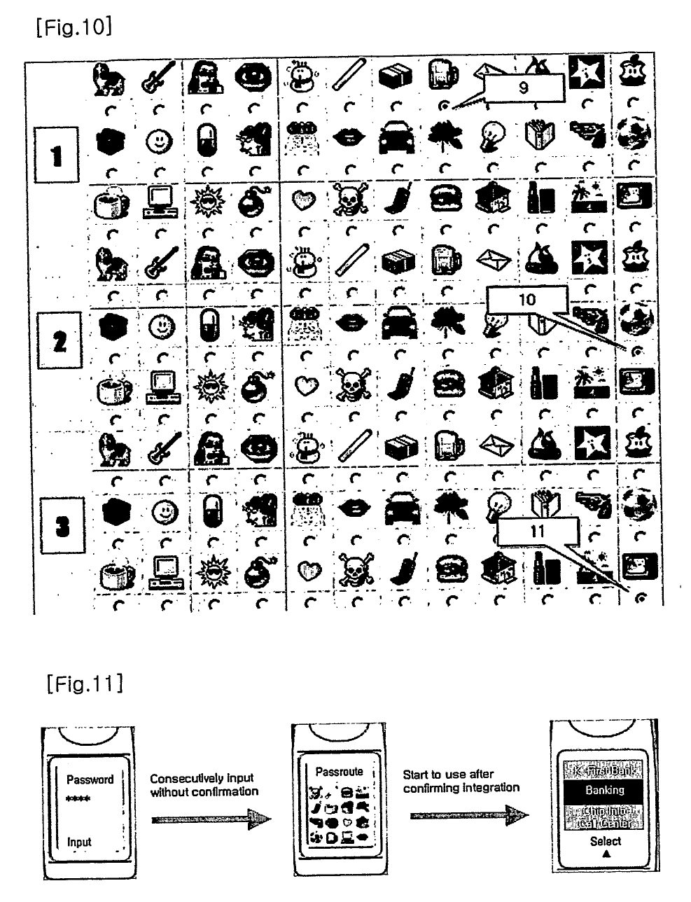

FIG. 10 illustrates a setting screen for producing a personalization set.

As shown in FIG. 10, if a user selects his key image and passage coordinate image from images which is much more than 16 necessary in a set and generates a personalization set including the selected images as shown in FIG. 9, bogus sets are produced so that it is difficult to include all the 3 images of a corresponding person.

Assuming that 3 images among 36 images as in FIG. 10 are selected and the remaining 13 images is randomly selected to produce the personalization set, the probability that specific 3 images are all included when selecting the 16 images from the 36 images is merely 7.8%. That is, the probability that a criminal passes through a bogus set and then steals a target user's key is 7.8%. If specific images are to be selected from 100 images, the probability is further dropped and results in 0.3%.

Furthermore, it is evident that the personalization set can be implemented to support a unique set by uploading images produced by a user.

Also, in order to steal a glance at a personalization set in advance and then attempt a phishing attack using a bogus personalization set, it will be effective to send an alarm message to a person even in an attempt that a criminal sees only the personalization set but does not pass. The alarm message can include an advice sentence reading that it is better to change a key because there is the possibility that the personalization set may be exposed.

Next, a method of preventing an attempt to steal a key by applying a personalization set, which is obtained by installing a hacking tool having an image capture function in others'computer so as to steal the above-described personalization set, to a bogus site for phishing will be described. Although capture can be prevented through an anti-capture technology, this method is to prepare for a case where a hacking tool that cannot be prevented through the anti-capture technology exists.

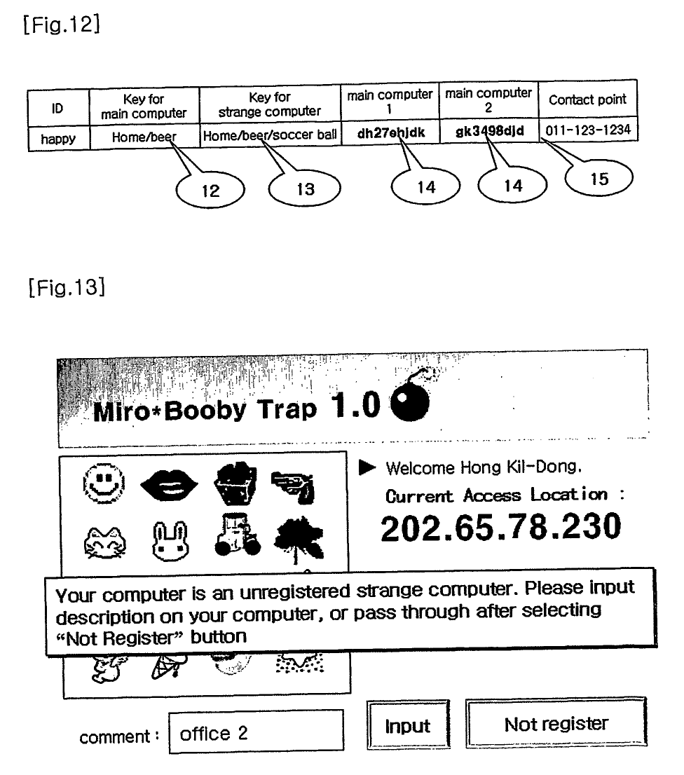

FIG. 12 shows an example of a user profile table for an authentication service according to the present invention. In this example, main computer information 14 is recorded every user.

FIG. 13 shows an example of an interface for registering a main computer according to the present invention.

When the personalization set according to the present invention is executed on-line, specific unique information 14 within a computer of a user can be recognized using, e.g., MAC address of a LAN card or the computer of the user can be recognized using cookie. If the computer is recognized as a computer that has not been registered in the user profile, an alarm message is sent to a contact point 15 designated by the user, and the interface for registering the main computer as shown in FIG. 13 is provided so that the user can take an necessary step.

The alarm message notifies the user of the fact that authentication has been attempted by a computer not registered by the user so that the user can prepare for personal information hacking.

Further, the interface for registering the main computer allows the user to register his computer, which is currently being used, as a main computer. At this time, the registered computer is recognized as the main computer of the user, and is thus treated differently from strange unregistered computers.

What the main computer of the user and the strange computers are differently treated means that keys for passing through authentication are set to be different. For example, a key 12 used in the main computer and a key 13 used in a strange computer can be set to be completely different, or all keys can pass through the strange computer but some of the keys can pass through the main computer. That is, although phishing is successful in the main computer, only the key 12 for the main computer is stolen, which makes it difficult for fraudulent use by an attacker who has to input the key 13 for the strange computer.

Furthermore, the method of confirming keys different every computer is effective in preventing fraudulent use in a strange computer even in authentication by an existing text input as well as authentication by the coordinate input. That is, if a password is 8 positions, 8 positions are all confirmed in the strange computer, but only 4 positions are confirmed in the main computer. It is thus possible to prevent fraudulent use in the strange computer although the password is stolen.

If the present invention is applied to a security access service, it is evident that there is a sufficient hacking-prevention effect although the access location tracking step is omitted. Further, it can be seen that a security effect is sufficient although a dual authentication step is not practiced.

Next, description will be given on a method in which the present invention is applied to devices such as a mobile phone, a door lock and a safe in a built-in manner.

In the mobile phone, the door lock, the safe and so on, there is no need to confirm who is who among numerous people like services on Internet or a bank. It is thus not necessary to confirm an ID and a password.

Therefore, there is less need to perform the above-described first and second authentication steps. Further, in these devices, the keyboard is a compact keyboard not a full keyboard like a computer keyboard. In this keyboard, it is convenient to input numbers, but inconvenient to input characters. For this reason, a password in this device is usually composed of only numbers. This results in a too narrow bandwidth of the password. Furthermore, since there is nothing meaning in numbers, a password related to personal information is used in finding meaningful numbers that can be easily memorized. This password is disadvantageous in that it can be easily analogized by third parties.

FIG. 11 shows an embodiment in which the present invention is applied to a mobile phone.

As shown in FIG. 11, in the case where a text password is first inputted and the input of coordinates is completed by presenting an image table for coordinate authentication without confirming the password, if it is determined whether to allow a passage by confirming the text password and the coordinates at a time, the number of cases is 10 thousands when a number password is only 4 positions, and if it is a 2-point passage rule in a 16 image table, the number of cases is 210. They are not simply added, but multiplied, resulting in 2.1 millions the total number of cases. This means that assuming that an hour is taken to find one number password, a full month is taken in order to find the full number password if 7 hours are invested a day.

To this end, the process can be programmed to allow a passage only when both the text input and the coordinate input are valid without the process of confirming the text input and the coordinate input intermediately.

The above-described built-in type is very useful in the door lock. This means that not only the bandwidth of a password widens, but also all pertinent persons can use the number password. That is, in an existing number key, since all constituent members uses a single key by, it is inconvenient to inform all the constituent members of a new password. Thus, it is very common to use the key for a long time without changing it. In the present invention, if keys as many as the number of constituent members are registered, each constituent member can manage each key separately. Also, since the bandwidth is sufficiently wide enough to be shared by a plurality of constituent members, it can be safely used in most door locks for an office. Furthermore, there is an advantage in that entrance and exit can be managed on a constituent member basis.

Furthermore, if a door lock to which advanced technologies such as an electronic chip or biomatrics are applied is used, the level of security does not drop to the level of security of a number key provided as an assistant key.

What is claimed is:

1. A security access service method in processing member login in an on-line service, comprising:
an authentication step by the input of text;
an access location tracking step;
an authentication step by the input of coordinates; and
an access history report step.

2. The security access service method as claimed in claim 1, wherein the access location tracking step is performed between the two authentication steps.

3. The security access service method as claimed in claim 1, wherein the access history report step includes the steps of:
if another access is attempted with a user being already accessed, comparing the location of a person who attempts access, which is obtained in the access location tracking step, with the access location of a current login status, and if the location of the user and the access location of the current login status are different, immediately reporting the access location of the person who attempts access to the user of the current login status through a screen, and
if the location of the user and the access location of the current login status are the same, the obtained positional information of the person who attempts access is always reported to the user upon next logging in.

4. The security access service method as claimed in claim 1, wherein the access history report step includes the step of, if the authentication step by the input of the coordinates fails, immediately sending an alarm message through message means that is designated by the user.

5. A security access service method in processing member login in an on-line service, comprising:
an authentication step by the input of text; and
an authentication step by the input of coordinates.

6. The security access service method as claimed in any one of claims 1 to 5, wherein the authentication step by the input of the coordinates comprises the steps of:
transmitting an image table in which a key image is randomly mixed with a plurality of other images to the screen of the user;
manipulating the entire images to have the same value at the same time according to a manipulation value of a keyboard or a mouse of the user;
confirming a position manipulated by the key image; and
if coordinates whose manipulation of a position is confirmed and key coordinates previously designated by the user coincide with each other, determining that authentication is successful, and if they do not coincide with each other, determining that that authentication is unsuccessful.

7. The security access service method as claimed in claim 6, wherein the key coordinates are positions designated using a second key image.

8. The security access service method as claimed in claim 7, further comprising the step of, if a first key image passes through a position designated by a booby trap key image through the manipulation of the user, determining that authentication is unsuccessful, and transmitting an alarm message to a PC of the user or an original owner of an ID.

9. The security access service method as claimed in claim 7, further comprising the steps of, if the user places the first key image at a position designated by a report key image and then confirms the manipulation, determining that authentication is successful, and allowing this fact to be automatically reported through a guard system.

10. A method of safely authenticating a user, comprising the steps of:
transmitting an image table in which a key image is randomly mixed with a plurality of other images to a screen of a user;
manipulating the entire images to have the same value at the same time according to a manipulation value of a keyboard or a mouse of the user;
confirming a position manipulated by the key image; and
if coordinates whose manipulation of a position is confirmed and key coordinates previously designated by the user coincide with each other, determining that authentication is successful, and if they do not coincide with each other, determining that that authentication is unsuccessful.

11. The safe authentication method as claimed in claim 10, wherein the key coordinates are positions designated using a second key image.

12. The safe authentication method as claimed in claim 11, further comprising the step of, if a first key image passes through a position designated by a booby trap key image through the manipulation of the user, determining that authentication is unsuccessful, and transmitting an alarm message to a PC of the user or an original owner of an ID.

13. The safe authentication method as claimed in claim 11, further comprising the steps of, if the user places a first key image at a position designated by a report key image and then confirms the manipulation, determining that authentication is successful, and allowing this fact to be automatically reported through a guard system.

14. The safe authentication method as claimed in any one of claim 1 to 9, further comprising the step of registering a personalization image table in which a construction image history of provided image tables is differently registered on a user basis.

15. The safe authentication method as claimed in claim 14, wherein the step of registering the personalization image table comprises the steps of:
allowing the user to select a key image and a through coordinate image or a terminal coordinate image from a group of images, which are much more than the number of images that are required in the personalization image table, and then to input the selected images;
allowing a server to randomly extract images as many as the number of images, which is necessary to complete the image table, from the remaining images except for the selected images; and
mixing the images that are selected and inputted by the user and the images that is selected by the server, and registering the personalization image table.

16. The safe authentication method as claimed in any one of claims 10 to 13, further comprising the step of inputting a text password, and
wherein the authentication process step includes determining that authentication is successful only when both the text password and the key coordinate are valid after the input of the text password and the key coordinates has been completed, and determining that authentication is unsuccessful if either the text password or the key coordinate is not valid.

17. The safe authentication method as claimed in any one of claims 1 to 9, 14 and 15, further comprising:
a key coordinate registration step of providing the interface for allowing the user to differently define key coordinates for a main computer and key coordinates for a strange computer, and registering the inputted information;
a terminal information acquisition step of acquiring recognized information of a computer of the user;
a terminal recognition step of determining the computer as the main computer or the strange computer based on the recognized information on the computer of the user, which is acquired in the terminal information acquisition step;
a main computer registration step of, if it is determined that the computer is the strange computer in the terminal recognition step, registering the computer information to provide a main computer registration interface that can be registered as the main computer, and registering the inputted information; and
a strange computer alarm step of, if the computer is determined to be the strange computer in the terminal recognition step, notifying the user of the alarm message regardless of the authentication result,
wherein the authentication step by the input of the coordinates includes determining whether the coordinates the manipulation of the position of which is confirmed and the key coordinates previously designated by the user coincide with each other, if the computer is determined to be the main computer in the terminal recognition step, confirming the key coordinates for the main computer, and if the computer is determined to be the stranger computer in the terminal recognition step, confirming the key coordinates for the strange computer.

18. The safe authentication method as claimed in claim 17, wherein the key coordinates are two or more, and all the key coordinates are confirmed in the strange computer, and only some of the key coordinates are confirmed in the main computer.

19. A method of safely authenticating a user, comprising the steps of:
a password registration step of providing the interface for allowing a user to differently define passwords for a main computer and passwords for a strange computer, and storing the inputted information;
a terminal information acquisition step of acquiring recognized information of a computer of the user;
a terminal recognition step of determining the computer as the main computer or the strange computer based on the recognized information of the computer of the user, which is acquired in the terminal information acquisition step;
a main computer registration step of, if it is determined that the computer is the strange computer in the terminal recognition step, registering the computer information to provide a main computer registration interface that can be registered as the main computer; and
an authentication processing step of, if the computer is determined the main computer in the terminal recognition step, confirming a password for the main computer, and if the computer is determined the strange computer in the terminal recognition step, confirming a password for the strange computer.

20. The safe authentication method as claimed in claim 19, further comprising the steps of:
providing the interface for allowing the user to register a contact point where the alarm message is received, and storing the inputted information; and
a strange computer alarm step of, if the computer is determined to be the strange computer in the terminal recognition step, notifying the alarm message to the contact point regardless of the authentication result.
